(19) United States
(12) Patent Application Publication
(10) Pub. No.: US 2026/0139544 A1
(43) Pub. Date: May 21, 2026

(54) METHOD FOR PRODUCING A CORNER CONNECTION, CONNECTING ELEMENT FOR A CORNER CONNECTION, AND CORNER CONNECTION

(71) Applicant: REHAU INDUSTRIES SE & CO. KG, Rehau (DE)

(72) Inventors: Ahmad AL-SHEYYAB, Rehau (DE); Norbert FINK, Eckental (DE); Nils GERBER, Rehau (DE); Igor GORBUNOV, Forchheim (DE); Stephan SELL, Magdeburg (DE); Frank SUTHOFF, Zweibrücken (DE)

(21) Appl. No.: 19/120,750

(22) PCT Filed: Oct. 10, 2023
(86) PCT No.: PCT/EP2023/077963

§ 371 Date: Apr. 11, 2025

(30) Foreign Application Priority Data
Oct. 12, 2022 (DE) 10 2022 126 595.1

(51) Int. Cl. E06B 3/968

(52) U.S. Cl. CPC E06B 3/9682

(57) ABSTRACT

The invention relates to a method for producing a corner connection (1) between two mitre-cut hollow-chamber profile portions (14, 14′) using a connecting element (2) which has two legs (3, 3′) arranged in an angled manner, depressions (4, 4′) on the outer side of the legs (3, 3′), and a channel system (10) in the legs for guiding a thermoplastic connecting compound, which channel system (10) has inflow openings (7, 7′) and also outlet openings (11, 11′) which open into the depressions (4, 4′), the method comprising: (a) providing the portions (14, 14′); (b) incorporating through-openings through the walls of the hollow-chamber profile in such a way that the through-openings and the inflow openings (7, 7′) of the channel system (10) are aligned when the legs (3, 3′) have been introduced into a respective hollow chamber (13, 13′) of the portions (14, 14′); (c) introducing the legs (3, 3′) into a respective hollow chamber (13, 13′) in such a way that the through-openings and the inflow openings (7, 7′) are aligned, wherein cavities delimited by the depressions (4, 4′) and inner walls of the hollow-chamber profile are formed; (d) introducing the connecting compound into the channel system (10) until the cavities delimited by the depressions (4, 4′) and inner walls are at least partially filled with the connecting compound; and (e) solidifying the connecting compound. The invention also relates to a corresponding connecting element (2) and a corresponding corner connection (1).

The present invention relates to a method for producing a corner connection between two mitre-cut portions of a hollow-chamber profile, in particular of a window and/or door hollow-chamber profile, using a connecting element. Furthermore, the present invention also relates to a connecting element for such a corner connection and to such a corner connection.

Corner connections of this type between two mitre-cut portions of a hollow-chamber profile are known in the prior art, particularly in the field of window and door frames. In particular, plastic windows and plastic doors made of thermoplastic materials such as polyvinyl chloride (PVC), in particular rigid PVC (PVC-U), are widely used. Due to the thermoplastic properties of the material forming the hollow-chamber profile portions, the portions are welded together in the mitre region to form a corresponding corner connection. This welding can be carried out mechanically in four positions simultaneously using appropriate welding machines, so that a generally rectangular frame is formed. Due to the lack of thermoplastic properties of the materials forming the profiles, the mitre-cut profile portions cannot be joined by welding in the case of metal profiles, in particular aluminium profiles, nor in the case of metal composite profiles and other composite profiles, for example made of plastic materials with fibrous reinforcing elements. For example, the profile portions of such profiles are screwed together to form corner connections or connected to each other using appropriate fastening pins. Additionally or alternatively, so-called corner connectors can also be used as mechanical connecting elements. Such corner connectors are connecting elements with two interconnected legs which are arranged in an angled manner to one another and are inserted into hollow chambers of the corresponding profile portions and mechanically fastened, for example by screwing or pinning. The corner connectors can also be fastened in the hollow chambers by gluing, wherein the adhesive used is applied to the corner connectors before they are introduced into the profiles and has an additional sealing effect in the finished corner connection. A corner connector of this type, which is both mechanically connected and adhesively bonded to the hollow-chamber profile, is disclosed, for example, in DE 10 2004 016 212B4 .

The disadvantage of such corner connections is that they cannot currently be produced in an automated fashion. In addition, when using adhesives, a curing time of several minutes must be allowed to elapse before the corner connection can be loaded. Furthermore, the use of such sealing adhesives complicates the recycling process for frames comprising such corner connections.

This is where the present invention comes in, which addresses the problem of at least partially overcoming the disadvantages of the prior art. In particular, the method according to the invention should enable the corner connections to be produced quickly, reliably and in an automated fashion. In addition, the corner connection obtained by the method according to the invention should be easily recyclable.

These and other problems are solved by a method having the features of claim 1, by a connecting element having the features of claim 7 and by a corner connection having the features of claim 11. Preferred embodiments of the method according to the invention, the connecting element according to the invention and the corner connection according to the invention are described in each of the dependent claims.

According to the present invention, it has been recognised that, irrespective of the material of the mitre-cut profile portions of the hollow-chamber profile, a corner connection can be produced in an automated fashion by feeding a thermoplastic connecting compound from the outer side of the resulting corner connection through the connecting element already inserted into the hollow chambers of the profile portions, in order to produce an integrally bonded connection between the connecting element and the interior of the hollow chamber of the profile portion into which the corresponding leg of the connecting element is inserted. For this purpose, inside the connecting element there is a channel system with inflow openings for allowing the connecting compound to flow into the connecting element and outlet openings that open into depressions on the surface of the connecting element. Through-openings in the outer walls of the hollow-chamber profile portions corresponding to the inflow openings of the connecting element are introduced into the hollow-chamber profiles by mechanical methods, for example by milling, punching or drilling. The thermoplastic connecting compound then flows through the channel system inside the connecting element and exits to the outside between the inner wall of the hollow chamber of the profile portion and the depressions in the legs of the connecting element. There, the thermoplastic connecting compound hardens or solidifies and thus creates an integrally bonded connection between the connecting element and the hollow-chamber profile portion. In this way, the corner connection according to the invention is formed.

Accordingly, the present invention lies in the provision of a method for producing a corner connection between two mitre-cut portions of a hollow-chamber profile, in particular a window and/or door hollow-chamber profile, using at least one connecting element, wherein the connecting element comprises two legs which are arranged in an angled manner to one another and can be at least partially introduced into a hollow chamber of the hollow-chamber profile, a plurality of depressions which are arranged on the outer side of the legs, and a channel system accommodated in the legs for guiding a thermoplastic connecting compound, wherein the channel system has inflow openings for allowing the connecting compound to flow into the channel system, and outflow openings which open into the depressions, wherein the method comprises the following steps:
(a) providing two mitre-cut portions of a hollow-chamber profile, in particular a window and/or door hollow-chamber profile;
(b) incorporating through-openings through the walls of the hollow-chamber profile in such a way that the through-openings and the inflow openings of the channel system are aligned when the legs of the connecting element have been introduced into a respective hollow chamber of the two portions of the hollow-chamber profile;
(c) introducing the legs of the connecting element into a respective hollow chamber of the two portions of the hollow-chamber profile in such a way that the through-openings and the inflow openings of the channel system are aligned, wherein cavities delimited by the depressions of the connecting element and inner walls of the hollow-chamber profile are formed;
(d) introducing a thermoplastic connecting compound through the through-openings into the channel system of the connecting element until the cavities delimited by the depressions of the connecting element and inner walls of the hollow-chamber profile are at least partially filled with the thermoplastic connecting compound; and
(e) solidifying the connecting compound.

Furthermore, the present provides a connecting element for a corner connection between two at least partially mitre-cut portions of a hollow-chamber profile, in particular of a window and/or door hollow-chamber profile, wherein the connecting element comprises two legs which are arranged in an angled manner to one another and which can be at least partially introduced into a hollow chamber of the hollow-chamber profile, a plurality of depressions which are arranged on the outer side of the legs, wherein the connecting element is characterized according to the present invention in that it further comprises a channel system accommodated in the legs for guiding a thermoplastic connecting compound, wherein the channel system has inflow openings for allowing the connecting medium to flow into the channel system and outflow openings which open into the depressions. Lastly, the present invention also provides a corner connection between two at least partially mitre-cut portions of a hollow-chamber profile, in particular of a window and/or door hollow-chamber profile, which corner connection has been produced by the method according to the present invention.

In the following, explanations which relate to the method according to the present invention and emphasise its advantages shall also apply equally to the connecting element according to the present invention and to the corner connection according to the present invention. Similarly, the explanations relating to the connecting element according to the present invention or the corner connection according to the present invention shall also apply to the method according to the present invention. Lastly, the same applies accordingly to the explanations relating to the connecting element according to the present invention and the corner connection according to the present invention, and vice versa.

According to the method according to the present invention, profile portions of the desired length are first produced from bars of a hollow-chamber profile, in particular of a window and/or door hollow-chamber profile, and are each mitre-cut at the ends. In particular, the mitre angle is preferably 45° at both ends of the profile portion. The hollow-chamber profiles can be, for example, plastic hollow-chamber profiles, for example made of thermoplastics such as polyvinyl chloride (PVC), in particular rigid PVC (PVC-U), and polyamides, in particular polyamide-6 or polyamide-6,6, metal profiles, in particular aluminium profiles, metal composite profiles, for example metal-plastic composite profiles, metal-wood composite profiles or other composite profiles, for example made of plastic materials with fibre-containing reinforcing elements. Such plastic profiles with fibre-containing reinforcing elements are preferably extruded or pultruded or pultruded and extruded hollow-chamber profiles made of a plastics matrix into which reinforcing fibres, for example continuous fibres or short and/or long fibre pieces, woven fabrics and/or laid scrims are integrated. The plastics matrix is preferably a material provided with talcum and/or chalk. Preferably, the materials used here can be polyvinyl chloride (PVC), polyamide (PA), in particular polyamide-6 or polyamide-6,6, polyacrylonitrile styrene acrylate (ASA), polymethylmethacrylate (PMMA), polyacrylonitrile butadiene styrene polymers (ABS), polypropylene (PP), polyethylene (PE), polybutylene terephthalate (PBT), polyethylene terephthalate (PET) or also polyphenylene sulphide (PPS), polyetherimide (PEI) as well as mixtures, blends and copolymers, terpolymers, multiblock polymers and/or dendritic oligomers of the aforementioned materials. The reinforcing fibres used are fabrics, bands, knitted fabrics, woven fabrics, laid scrims and/or tapes, preferably as inorganic glass fibres, carbon fibres or bio-based fibres such as wood fibres, cellulose or chemical fibres, wherein mixtures of two of the aforementioned fibre materials or all three fibre materials are also within the scope of the present invention. However, glass fibres are particularly preferably used.

Through-openings are then incorporated in the walls of the hollow-chamber profile, preferably by means of drilling, milling, pinning, self-drilling screws with hollow chambers. The position of the through-openings is selected here so that the through-openings and the inflow openings of the channel system of the connecting element are aligned when the legs of the connecting element are each introduced into a hollow chamber of the two portions of the hollow-chamber profile. In this stage of the method, further openings can also be made in the walls of the hollow-chamber profile, for example for the passage of fastening elements, preferably for pre-fixing the corner connection to be formed according to the present invention.

The two legs of the connecting element are then each inserted into a hollow chamber of the corresponding portion in such a way that the through-openings through the outer walls of the hollow-chamber profile and the inflow openings in the connecting element are aligned with each other. Preferably, the dimensions of the connecting element are selected such that the outer side of the connecting element is at least partially in contact with the inner walls of the hollow chamber. In this way, cavities are formed between the depressions on the outer side of the connecting element and the inner walls of the hollow chamber. These cavities subsequently serve to accommodate part of the connecting compound.

In the subsequent step, the thermoplastic connecting compound is introduced into the corner connection to be formed according to the present invention. In preferred embodiments of the method according to the present invention, this is carried out in a modified injection moulding process. The unit formed of the mitre-cut hollow-chamber profile portions with the connecting element inserted into the hollow chambers is fixed in the injection moulding device and the connecting compound is injected inside the injection moulding device through the through-openings into the inflow openings of the channel system of the connecting element. The material of the connecting compound is preferably selected here in such a way that, in the hardened state, it forms an integrally bonded connection both to the material of the connecting element according to the present invention and to the interior of the hollow chamber of the hollow-chamber profile used in the corner connection to be produced. Preferably, the material of the connecting compound is a thermoplastic material which may contain fibre portions, in particular portions of glass fibres, carbon fibres or aramid fibres. The quantity of the thermoplastic connecting compound is selected such that a sufficiently stable connection according to the present invention is formed and the connecting compound does not cause the outer walls of the hollow-chamber profile to bulge outwards and/or connecting compound to escape through the mitre joint of the corner connection. Suitable thermoplastic materials have proven to be in particular those materials that have been stated in relation to the plastic matrix of the composite profile that can be used as a hollow-chamber profile. Preferred materials used for the thermoplastic connecting compound are therefore polyvinyl chloride (PVC), polyamide (PA), in particular polyamide-6 or polyamide-6,6, polyacrylonitrile styrene acrylate (ASA), polymethylmethacrylate (PMMA), polyacrylonitrile butadiene styrene polymers (ABS), polypropylene (PP), polyethylene (PE), polybutylene terephthalate (PBT), polyethylene terephthalate (PET), polyphenylene sulphide (PPS), polyetherimide (PEI) as well as mixtures, blends and copolymers or terpolymers, multiblock polymers and dendritic oligomers of the aforementioned materials. These materials are particularly preferably fibre-reinforced, in particular glass fibre-reinforced, carbon fibre-reinforced or aramid fibre-reinforced. The length of the individual fibre pieces is selected in such a way that they do not excessively hinder the introduction of the curable connecting compound into the corner connection to be produced.

Finally, the connecting compound solidifies in the formed corner connection. If an injection moulding device is used, the corner connection can now be removed from the injection moulding device.

In particularly preferred embodiments of the present invention, the method according to the present invention is carried out simultaneously in different positions, so that several corner connections according to the present invention are produced at the same time. Preferably, this forms a circumferential frame, in particular a window or door frame.

With regard the method according to the present invention, it can be useful if the connecting element is pre-fixed before step (d) by driving at least one fastening element through an outer wall of the respective portion of the hollow-chamber profile into the respective leg of the connecting element. Pre-fixing of this kind can reduce the risk of the connecting compound widening the gap between the profile portions. Appropriate screws, bolts or fastening pins can be used as fastening elements. It is advantageous if appropriate holes are made in the outer wall of the hollow profile portions for allowing the fastening elements to pass through. It is also advantageous if corresponding receptacles for the fastening elements are provided in the legs of the connecting element. Alternatively or additionally, a clamping device for pre-fixing is also possible, which engages in the fastening holes, for example, until the connecting compound has solidified and is then released. Preferably, the pre-fixing causes the connection to be pulled together by simultaneous external force on all frame parts. This can preferably be achieved by pinning or screwing the connecting element to the profile portions, or by a releasable gripping device that engages in the pinning holes until the connecting compound hardens and is then released again.

Additionally or alternatively, it can be advantageous if the connecting element, in the joint region of the two legs, has at least one joint depression, into which a joint opening of the channel system opens, wherein the joint depression is at least partially filled with the thermoplastic connecting compound in step (d). This achieves sealing of the corner connection according to the present invention in the joint region.

It may also be preferable for the curable connecting compound to be formed as a thermoplastic compound. Thermoplastic compounds can harden quickly, which ensures short cycle times during the automated execution of the method according to the present invention. In particular, polyvinyl chloride (PVC), polyamide (PA), in particular polyamide-6 or polyamide-6,6, polyacrylonitrile styrene acrylate (ASA), polymethylmethacrylate (PMMA), polyacrylonitrile butadiene styrene polymers (ABS), polypropylene (PP), polyethylene (PE), polybutylene terephthalate (PBT), polyethylene terephthalate (PET), polyphenylene sulphide (PPS), polyetherimide (PEI) as well as mixtures, blends and copolymers or terpolymers, multiblock polymers and dendritic oligomers of the aforementioned materials have proven to be suitable materials as thermoplastic compounds. These materials are particularly preferably fibre-reinforced, in particular glass fibre-reinforced, carbon fibre-reinforced, natural fibre-reinforced or aramid fibre-reinforced. It is particularly preferable to use the plastics material of the hollow-chamber profiles used to form the corner connection according to the present invention as the plastics material of the thermoplastic compound. The two plastics materials can be fibre-reinforced independently of each other or not. This favours the recycling of the corner connection according to the present invention after its intended use.

It can also be favourable if the connecting element, in particular the channel system of the connecting element, is preheated before step (d). This can preferably be done by blowing hot air into the channel system of the connecting element. The hot air preferably has a temperature here above 200° C. Preheating the connecting element prevents premature solidification of the thermoplastic connecting compound.

With regard to the connecting element according to the present invention, it may be preferable if each leg further comprises at least one receptacle for a fastening element for pre-fixing the connecting element in each case to one of the portions of the hollow-chamber profile. The corresponding receptacles serve to accommodate fastening elements, such as screws, bolts or fastening pins, for pre-fixing the hollow-chamber profile portions during the execution of the method according to the present invention.

It can also be helpful if the connecting element, in the joint region of the two legs, has at least one joint depression, into which a joint opening of the channel system opens. During the method according to the present invention, the joint depression can thus be filled with a hardenable connecting compound which, when hardened, contributes to sealing the joint region of the hollow-chamber profile portions.

Metals, in particular aluminium and stainless steel, alloys, in particular an aluminium die-casting alloy, a zinc die-casting alloy and an aluminium-zinc die-casting alloy, acrylonitrile-styrene-acrylic ester (ASA), polyamides (PA), in particular PA-6 and PA-6,6, polyphenylsulfone (PPSU), polyvinylidene fluoride (PVDF), polyethersulfone (PES), polysulfone (PSU), polyphenylene sulfide (PPS), acrylonitrile-butadiene-styrene copolymer (ABS), polyoxymethylene (POM) and polyester carbonate (PESC) as well as copolymers and blends of these polymers, wherein these polymer materials can also be used fibre-reinforced, in particular glass fibre-reinforced, carbon fibre-reinforced or aramid fibre-reinforced, have proven to be particularly suitable materials for the connecting element according to the present invention. It is preferred here that the connecting element is a component made of glass fibre-reinforced PA-6.

The connecting element according to the present invention and the hollow-chamber profile used in the method according to the present invention as well as individual parts thereof, can also be manufactured line by line or layer by layer using a line-building or layer-building manufacturing process (e.g. 3D printing).

Preferably, however, the connecting element according to the present invention is produced by injection moulding or die casting. The hollow-chamber profiles are preferably produced by extrusion or pultrusion.

In the following, the present invention will be explained in detail with reference to the embodiments shown in the figures, in which

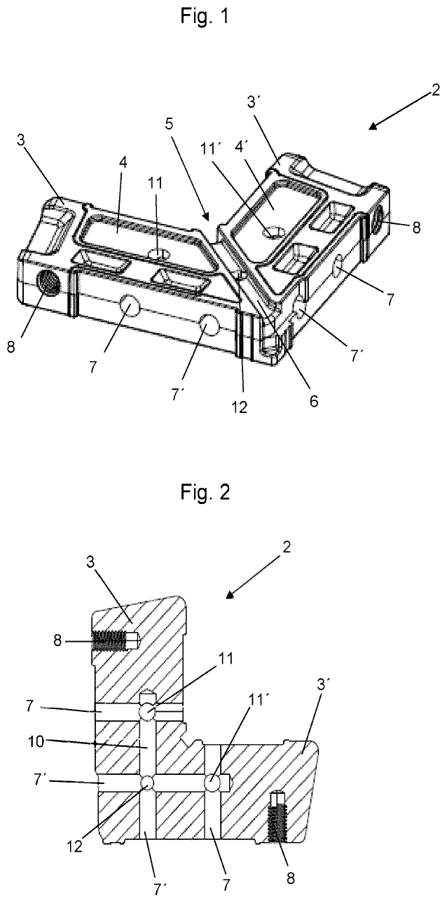

FIG. 1 shows a perspective view of a connecting element according to one embodiment of the present invention;

FIG. 2 shows a cross-sectional view of the connecting element according to the invention shown in FIG. 1;

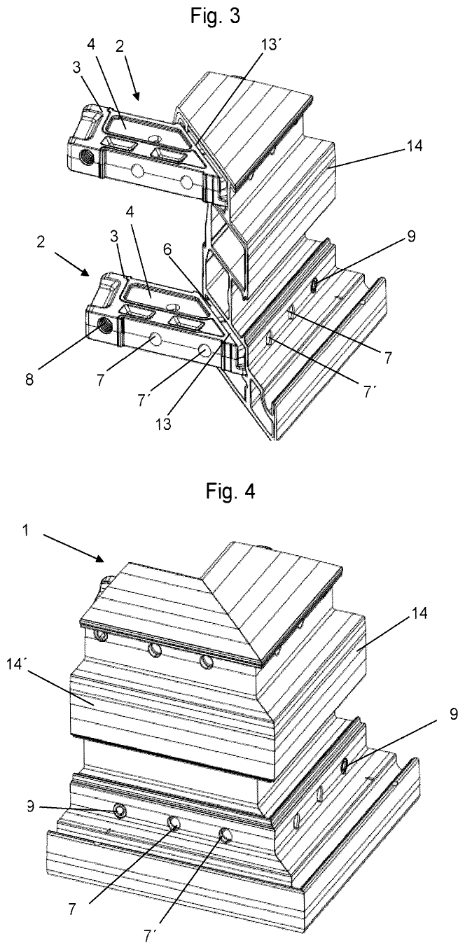

FIG. 3 shows a perspective view of a mitre-cut window hollow-chamber profile portion, wherein the legs of a connecting element according to the invention as shown in FIG. 1 are inserted into one each of two hollow chambers of the profile portion; and

FIG. 4 shows a perspective view of the corner connection formed according to the invention.

The present invention is directed to a method for producing a corner connection 1, wherein such a connection 1 according to the present invention comprises at least one connecting element 2 according to the present invention. An embodiment of a connecting element 2 according to the present invention is shown in FIG. 1 in a perspective view.

According to the embodiment shown in FIG. 1, the connecting element 2 according to the present invention is configured in the form of injection-moulded parts made of glass fibre-reinforced polyamide-6. According to this embodiment, the proportion of glass fibres in the material forming the connecting element 2 according to the present invention is 30% by weight.

In this embodiment, the connecting element 2 according to the present invention is formed from two legs 3, 3′ arranged at right angles to each other. There are several depressions 4, 4′ on the outer side of the connecting element 2. Such depressions 4, 4′ are also located on the opposite outer side of the two legs 3, 3′. In addition, a joint depression 6 is arranged in the joint region 5 of the two legs 3, 3′.

In the embodiment of the connecting element 2 according to the present invention shown in FIG. 1, there are two inflow openings 7, 7′ and a receptacle 8 for a fastening element 9 on each of the narrow sides of the legs 3, 3′.

The inflow openings 7, 7′ open into a channel system 10, which is clearly recognisable in the cross-sectional view of the connecting element 2 according to the present invention as shown in FIG. 2. The channel system 10 leads from the inflow openings 7, 7′ to outlet openings 11, 11′, which each open into depressions 4, 4′, and to a joint opening 12, which opens into the joint depression 6.

FIG. 3 shows a situation of the method according to the present invention, in which two connecting elements 2 according to FIG. 1 and FIG. 2 are each inserted with their leg 3′ into hollow chambers 13, 13′ of a mitre-cut portion 14 of a hollow-chamber profile. The connecting elements 2 are positioned in such a way that the respective joint depression 6 of the connecting element 2 is located in the mitred region of the hollow-chamber profile portion 14. In addition, the outer sides of the connecting elements 2 are partially in contact with the inner walls of the hollow chambers 13, 13′. In the outer walls of the profile portion 14 there are through-openings, which are aligned with the inflow openings 7, 7′ in the leg 3′ of the connecting element 2 according to the present invention. In addition, the portion 14 has a further hole that is aligned with the receptacle 8 for a fastening element 9, but is slightly offset in the longitudinal direction with respect to the preload. The through-openings and the further hole can be made in the profile portion 14, for example by drilling using a CNC drilling centre or using a suitable drilling template.

A further hollow-chamber profile portion 14′, mitre-cut to match the profile portion 14, is now pushed onto the free legs 3 of the connecting elements 2 in such a way that the free legs 3 of the connecting elements 2 in FIG. 3 engage in the corresponding hollow chambers 13, 13′ of the hollow-chamber profile portion 14′, wherein the outer sides of the legs 3 of the connecting elements 2 again partially rest against the inner walls of the hollow chambers 13, 13′ of the hollow-chamber profile portion 14′. The hollow-chamber profile portion 14′ also has, in the outer walls, through-openings and a further hole which correspond to those of the hollow-chamber profile portion 14. The hollow-chamber profile portion 14′ is in turn positioned on the leg 3 of the connecting element 2 according to the present invention in such a way that the respective joint depression 6 of the connecting element 2 is also located in the mitred region of the hollow-chamber profile portion 14′.

In the resulting arrangement, cavities are formed between the depressions 4, 4′ on the outer side of the respective connecting element 2 and the inner walls of the hollow chambers 13, 13′, which subsequently serve to accommodate part of the hardenable connecting compound to be injected into the arrangement.

In the embodiment shown, the hollow-chamber profiles 13 for the portions 14, 14′ are extruded profiles made of glass fibre-reinforced polyamide-6.

To pre-fix the corner connection 1 to be formed, fastening pins 9 are now inserted into the receptacles 8 in the legs 3, 3′ of the respective connecting element 2 according to the present invention. Pre-fixing in this way can reduce the risk of the gap in the mitred region of the hollow-chamber profile portions 14, 14′ being enlarged when the hardenable connecting compound is injected.

Now the arrangement formed of the two connecting elements 2 according to the present invention and the mitre-cut hollow-chamber profile portions 14, 14′ is introduced into a corresponding injection moulding device and fixed therein. In the injection moulding device, a hardenable connecting compound is now injected through the through-openings in the outer walls of the profile portions 14, 14′ into the inflow openings 7, 7′ in the legs 3, 3′ of the connecting elements 2 and from there passes through the outlet openings 11, 11′ into the cavities formed between the depressions 4, 4′ and the inner walls of the hollow chambers 13, 13′. In addition, the hardenable connecting compound also flows through the joint opening 12 into the joint depression 6. In the shown embodiment of the present invention, polyamide-6 was used as the hardenable connecting compound. The solidification of the hardenable connecting compound creates an integrally bonded connection between the connecting elements 2 according to the present invention and the hollow-chamber profile portions 14, 14′. The hardenable connecting compound in the joint depression 6 effectively seals the mitred region of the hollow-chamber profile portions 14, 14′ against the penetration of moisture.

After the hardenable connecting compound has solidified, the corner connection 1 according to the present invention formed in this way can be removed from the injection moulding device and the casting can be separated. The corner connection 1 formed in this way is shown in FIG. 4 in a perspective view. The corner connection 1 according to the present invention has excellent corner breaking strength. Since both the hollow-chamber profile portions 14, 14′, the connecting elements 2 according to the present invention and the hardenable connecting compound are based on the same plastics material, the recyclability of the corner connection 1 according to the present invention is improved. Furthermore, the corner connection 1 according to the present invention can be loaded immediately after the hardenable connecting compound has solidified, so that there is no need for long hardening times for the hardenable connecting compound. Accordingly, short cycle times can be achieved in automated processes.

The present invention has been described in detail by way of example with reference to the embodiment of the present invention shown in the figures. It is understood that the present invention is not limited to the embodiments shown in the figures. Rather, the scope of the present invention results from the appended claims. The figures show a method for producing a corner connection of a window hollow-chamber profile, a corresponding connecting element and a corresponding corner connection of a window frame. Accordingly, the present invention is also explained in relation to such a corner connection for a window frame. It is understood that the present invention can also be applied accordingly to the production of other connections, for example a corner connection of a door frame, a mullion connection, a corner connection in automotive construction (car and/or lorry construction), in refrigeration unit construction (in particular refrigeration unit frames), in air-conditioning systems, and in aircraft and shipbuilding.

1. A method for producing a corner connection between two mitre-cut portions of a hollow-chamber profile, in particular of a window and/or door hollow-chamber profile, using at least one connecting element, wherein the connecting element has two legs which are arranged in an angled manner to one another and can be at least partially introduced into a hollow chamber of the hollow-chamber profile, a plurality of depressions which are arranged on the outer side of the legs, and a channel system accommodated in the legs for guiding a thermoplastic connecting compound, wherein the channel system has inflow openings for allowing the compound to flow into the channel system, and outlet openings which open into the depressions, wherein the method comprises the following steps:
(a) providing two mitre-cut portions of a hollow-chamber profile, in particular a window and/or door hollow-chamber profile;
(b) incorporating through-openings through the walls of the hollow-chamber profile in such a way that the through-openings and the inflow openings of the channel system are aligned when the legs of the connecting element have been introduced into a respective hollow chamber of the two portions of the hollow-chamber profile;
(c) introducing the legs of the connecting element into a respective hollow chamber of the two portions of the hollow-chamber profile in such a way that the through-openings and the inflow openings of the channel system are aligned, wherein cavities delimited by the depressions of the connecting element and inner walls of the hollow-chamber profile are formed;
(d) introducing a thermoplastic connecting compound through the through-openings into the channel system of the connecting element until the cavities delimited by the depressions of the connecting element and inner walls of the hollow-chamber profile are at least partially filled with the thermoplastic connecting compound; and
(e) solidifying the connecting compound.

2. The method according to claim 1, wherein before step (d), the connecting element is pre-fixed by driving at least one fastening element through an outer wall of the respective portion of the hollow-chamber profile into the respective leg of the connecting element.

3. The method according to claim 1 wherein
the connecting element, in the joint region of the two legs, has at least one joint depression, into which a joint opening of the channel system opens, wherein the joint depression is at least partially filled with the thermoplastic connecting compound in step (d).

4. The method according to claim 1, wherein the connecting compound is formed as a thermoplastic compound.

5. The method according to claim 4, wherein polyvinyl chloride (PVC), polyamide (PA), in particular polyamide-6 or polyamide-6,6, polyacrylonitrile styrene acrylate (ASA), polymethylmethacrylate (PMMA), polyacrylonitrile butadiene styrene polymers (ABS), polypropylene (PP), polyethylene (PE), polybutylene terephthalate (PBT), polyethylene terephthalate (PET), polyphenylene sulphide (PPS), polyetherimides (PEI) as well as mixtures, blends and copolymers or terpolymers, multiblock polymers and dendritic oligomers of the aforementioned materials can be used as thermoplastic compound, wherein the aforementioned materials can also be fibre-reinforced, in particular glass fibre-reinforced, natural fibre-reinforced or aramid fibre-reinforced.

6. The method according to claim 1, wherein the connecting element, in particular the channel system of the connecting element, is preheated before step (d).

7. A connecting element for a corner connection between two at least partially mitre-cut portions of a hollow-chamber profile, in particular of a window and/or door hollow-chamber profile, wherein the connecting element comprises two legs which are arranged in an angled manner to one another and can be at least partially introduced into a hollow chamber of the hollow-chamber profile, a plurality of depressions which are arranged on the outer side of the legs, wherein
the connecting element further comprises a channel system accommodated in the legs for guiding a thermoplastic connecting compound, wherein the channel system has inflow openings for the inflow of the connecting medium into the channel system and outlet openings which open into the depressions.

8. The connecting element according to claim 7, wherein each leg further has at least one receptacle for a fastening element for pre-fixing the connecting element in each case to one of the portions of the hollow-chamber profile.

9. The connecting element according to claim 7, wherein the connecting element, in the joint region of the two legs, has at least one joint depression, into which a joint opening of the channel system opens.

10. The connecting element according to claim 7, wherein
the connecting element can be provided as a component made from a metal, in particular aluminium, stainless steel, an aluminium die-casting alloy, a zinc die-casting alloy and an aluminium-zinc die-casting alloy, acrylonitrile-styrene-acrylic ester (ASA), a polyamide (PA), in particular PA-6 and PA-6,6, acrylate polymers (PMMA), polyetherimides (PEI), polyphenylsulfone (PPSU), polyvinylidene fluoride (PVDF), polyethersulfone (PES), polysulfone (PSU), polyphenylene sulfide (PPS), acrylonitrile-butadiene-styrene copolymer (ABS), polyoxymethylene (POM) and polyester carbonate (PESC) as well as a copolymer or blend of these polymers, wherein these polymer materials can also be fibre-reinforced, in particular glass fibre-reinforced or aramid fibre-reinforced, and/or can be provided with fillers, in particular talcum, chalk, hollow glass beads, glass beads, glass plates.

11. A corner connection between two at least partially mitre-cut portions of a hollow-chamber profile, in particular a window and/or door hollow-chamber profile, produced by a method according to claim 1.

12. The corner connection according to claim 11, wherein the hollow-chamber profile is formed as a plastics hollow-chamber profile, preferably made of thermoplastics such as polyvinyl chloride (PVC), in particular rigid PVC (PVC-U), and polyamides, in particular polyamide-6 or polyamide-6,6, as a metal profile, preferably as an aluminium profile, as a metal composite profile, preferably as a metal-plastic composite profile, metal-wood composite profile or as another composite profile, preferably made of plastics materials with fibre-containing reinforcing elements.
